(19) United States
(12) Patent Application Publication
(10) Pub. No.: US 2017/0166720 A1
(43) Pub. Date: Jun. 15, 2017

(54) TANNIN-MODIFIED POROUS MATERIAL AND METHODS OF MAKING SAME

(71) Applicant: Case Western Reserve University, Cleveland, OH (US)

(72) Inventors: David A. Schiraldi, Shaker Heights, OH (US); Xiaolong Lang, University Heights, OH (US)

(73) Assignee: Case Western Reserve University, Cleveland, OH (US)

(21) Appl. No.: 15/316,331

(22) PCT Filed: Jun. 4, 2015
(86) PCT No.: PCT/US2015/034180

§ 371 Date: Dec. 5, 2016

Related U.S. Application Data
(60) Provisional application No. 62/008,157, filed on Jun. 5, 2014.

(51) Int. Cl. C08J 9/28; C08J 9/00

(52) U.S. Cl. CPC C08J 9/28; C08J 9/0066; C08J 2201/048; C08J 2205/026; C08J 2379/02

(57) ABSTRACT

The present disclosure provides an aerogel formed of a tannin-containing porous material including a polymeric material, a tannin, and a clay. In some embodiments, the tannin-containing porous material is produced by forming an aerogel precursor including a polymeric material, a tannin, and a liquid dispersion medium; freezing the aerogel precursor; and freeze drying. In other embodiments, the tannin-containing porous material is produced by coating a formed porous aerogel material with a tannin-containing coating solution including tannin dispersed therein. The aerogel provides a flame retardant material having improved mechanical properties.

### RELATED APPLICATION DATA

This application claims the benefit of U.S. Provisional Application No. 62/008,157 filed Jun. 5, 2014, the contents of which are hereby incorporated by reference in their entirety.

### TECHNICAL FIELD

The present disclosure relates generally to aerogels, and in particular, to tannin-modified aerogel compositions and composites, and methods of making the same.

### BACKGROUND

Polymeric foams such as polystyrene foams, epoxy foams, and the like have been conventionally used in packaging, insulation, and structural applications. These polymeric foams may provide mechanical support and/or protection. However, they are usually highly flammable due to their chemical compositions and high specific surface areas. Halogenated flame retardants are most commonly used as additives to the polymeric foam in order to reduce its inherent flammability. But polymeric foams including halogenated flame retardants suffer from toxicity and adverse environmental impacts, as well as loss of mechanical properties in the host polymer.

Aerogels have recently been shown to be potential replacements for polymer foams used in packaging, insulation, and structural applications. But flammability and/or the mechanical properties of the aerogel may be an issue with such materials.

### SUMMARY

The present disclosure provides tannin-modified aerogel compositions and composites. The tannins may be incorporated into the aerogel during the aerogel formation (e.g., included in the aerogel precursor) and/or after the aerogel formation (e.g., via coating of the formed aerogel). The tannin-modified aerogel compositions of the present disclosure may provide an environmentally friendly flame retardant material. In addition, mechanical properties of the tannin-modified aerogel of the present disclosure may be improved.

In accordance with one aspect of the present disclosure, a method of forming a tannin-modified porous material includes: forming an aerogel precursor, the aerogel precursor including a polymeric material, a tannin, and a liquid dispersion medium; freezing the aerogel precursor to solidify the liquid dispersion medium; and freeze drying the aerogel precursor to sublime the dispersion medium and form the tannin-modified porous material.

In one embodiment, the polymeric material includes an epoxy.

In another embodiment, the polymeric material is triethylenetetramine and 1, 4-butanediol diglycidyl ether.

In another embodiment, the polymeric material is present in the aerogel precursor in an amount from about 1 wt % to about 40 wt %.

In another embodiment, the aerogel precursor is montmorillonite clay.

In another embodiment, the clay is present in the aerogel precursor in an amount from about 0.25 wt % to about 15 wt %.

In another embodiment, the liquid dispersion medium includes water.

In another embodiment, the tannin is tannic acid.

In another embodiment, the tannin is present in the aerogel precursor in an amount less than about 2.5 wt %.

In another embodiment, the method further includes coating the formed tannin-modified porous material with a tannin-containing coating solution including an additional tannin dispersed therein.

In another embodiment, the additional tannin is tannic acid.

In another embodiment, the additional tannin is provided in the tannin-containing coating solution in an amount less than about 2.5 wt %.

In another embodiment, the tannin-containing coating solution includes tannic acid and ferric iron.

In another embodiment, the ferric iron is provided in the tannin-containing coating solution in an amount less than about 0.025 wt %.

In another embodiment, the tannin-containing coating solution includes ethanol.

In another embodiment, the tannin-containing coating solution is coated on the formed porous material by immersing, spraying, or painting.

In another embodiment, the method further includes drying the coated tannin-containing coating solution to evaporate the solvent.

In another embodiment, a tannin-modified porous material is formed by the method.

In accordance with another aspect of the present disclosure, a method of forming a tannin-modified porous material includes: forming an aerogel precursor, the aerogel precursor including a polymeric material and a liquid dispersion medium; freezing the aerogel precursor to solidify the liquid dispersion medium; freeze drying the aerogel precursor to sublime the dispersion medium and form a porous material; and coating the formed porous material with a tannin-containing coating solution including a tannin dispersed therein.

In one embodiment, the tannin is tannic acid.

In another embodiment, the tannin is provided in the tannin-containing coating solution in an amount less than about 2.5 wt %.

In another embodiment, the coating solution includes a tannic acid and ferric iron.

In another embodiment, the ferric iron is provided in the tannin-containing coating solution in an amount less than about 0.025 wt %.

In another embodiment, the tannin-containing coating solution is ethanol.

In another embodiment, the coating solution is coated on the formed porous material by immersing, spraying, or painting.

In another embodiment, the method further includes drying the coated tannin-containing coating solution to evaporate the solvent.

In another embodiment, the polymeric material includes an epoxy.

In another embodiment, the polymeric material is triethylenetetramine and 1, 4-butanediol diglycidyl ether.

In another embodiment, the polymeric material is present in the aerogel precursor in an amount from about 1 wt % to about 40 wt %.

In another embodiment, the aerogel precursor is montmorillonite clay.

In another embodiment, the clay is present in the aerogel precursor in an amount from about 0.25 wt % to about 15 wt %.

In another embodiment, the liquid dispersion medium includes water.

In another embodiment, a tannin-modified porous material is formed by the method.

In accordance with another aspect of the present disclosure, an aerogel is formed of a tannin-modified porous material, the tannin-modified porous material including: polymeric material present in an amount from about 5 to about 95 parts per 100 parts by weight of the tannin-modified aerogel; a tannin present in an amount from about 1 to about 20 parts per 100 parts by weight of the tannin-modified aerogel; and a clay present in an amount from about 1 to about 25 parts per 100 parts by weight of the tannin-modified aerogel.

In one embodiment, the polymeric material is triethylenetetramine and 1, 4-butanediol diglycidyl ether.

In another embodiment, the clay is montmorillonite clay.

In another embodiment, the tannin is tannic acid.

In another embodiment, the aerogel includes a coating layer including an additional tannin.

In another embodiment, the coating layer further includes ferric iron.

In another embodiment, the aerogel is a packaging material.

In another embodiment, the aerogel is an insulating material.

The foregoing and other features are hereinafter described in greater detail with reference to the accompanying drawings.

### BRIEF DESCRIPTION OF THE DRAWINGS

FIG. 1 is a schematic representation of a synthesis of exemplary polymers utilized in accordance with the present disclosure.

FIG. 2 is a schematic representation of an exemplary pH-responsive synthesis and disassembly of Fe(III)-tannic acid.

FIG. 3 is an image of exemplary aerogels produced in accordance with the present disclosure.

FIG. 4 is a graph showing the compression behavior of exemplary aerogels produced in accordance with the present disclosure.

FIG. 5 is a graph showing the compression behavior of exemplary aerogels produced in accordance with the present disclosure.

FIG. 6 is a graph showing the compression behavior of exemplary aerogels produced in accordance with the present disclosure.

FIGS. 7-12 are scanning electron microscope (SEM) images of exemplary aerogels produced in accordance with the present disclosure.

FIG. 13 is a graph showing the heat release rate of exemplary aerogels produced in accordance with the present disclosure.

FIG. 14 is a graph showing the total heat release rate of exemplary aerogels produced in accordance with the present disclosure.

### DETAILED DESCRIPTION

An aerogel is a porous solid that is formed from a gel, in which the liquid that fills the pores of the solid has been replaced with a gas. Aerogels are generally produced by drying the gel either by a supercritical drying or by freeze drying. When the liquid is removed from the network, the solid network is left behind. Shrinkage of the gel's solid network during drying is negligible or all-together prevented due in part to the minimization of capillary forces acting on the network as the liquid is expended. Accordingly, the formed aerogel structure may be highly porous and include a three-dimensional, open-cell body. Aerogels are generally characterized as having high porosity and high specific surface area (e.g., about 100 m²/g to about 1600 m²/g). Aerogels also possess relatively low densities, generally in the range of 0.004 g/cm³ to about 0.5 g/cm³ (e.g., about 90% air to about 98% air).

As described herein, highly porous, aerogel like structures that include a three-dimensional, open-cell body may be formed using two-phase systems, including dispersions, emulsions, solutions, suspensions and latexes. A first phase, for example a polymer or polymer precursor, is dispersed, suspended or emulsified in a second phase, referred to herein as a dispersion medium, to form the two phase system, referred to as a dispersion (e.g., an aerogel precursor). The dispersion is first subjected to freezing to solidify the dispersion medium, and then freeze dried to remove the bulk of the dispersion medium, leaving behind a solid, polymer containing skeleton of the dispersion. While these highly porous structures are not formed from a gel, the term “aerogel” as used herein includes these dispersion derived structures.

In accordance with the present disclosure, one or more tannins (e.g., tannic acid, C₇₆H₅₂O₄₆), which may be natural products found in tree bark and other biological sources, may be incorporated into the aerogel and/or coated on the aerogel. Incorporation of the tannins into the aerogel may be provided by combining the one or more tannins with the aerogel precursor, mixing, freezing, and freeze drying, to produce a tannin-modified aerogel material. By coating, a solution or dispersion of the one or more tannins may be applied and incorporated into the formed aerogel, by a process such as soaking the aerogel, spraying the aerogel, painting the aerogel, or other suitable methods of applying a coating to a solid substrate. An aerogel including a tannin material may be referred to as a tannin-modified aerogel.

Aerogels in accordance with the present application may be produced using various polymers, dispersions, clays, additives, fillers, fibers, etc. For example, aerogels in accordance with the present application may be polymer based. As such, an aerogel may be formed from one or more polymers in combination with a dispersion medium (and in some embodiments, with one or more tannins). In other embodiments, one or more clays, additives, fillers, fibers, etc the aerogel may be combined with the polymer and dispersion (and in some embodiments, with one or more tannins) to form the aerogel.

The polymer used in the aerogel may be one or more monomers, polymers, copolymers, or combinations thereof. As used herein, the term “polymer” may refer any of the described or similar monomers, polymers, copolymers, or combinations. As an example, the polymers encompassed in these aerogels are those that can be converted into aqueous solutions, dispersions, latexes, suspensions and similar stable or quasi-stable forms.

The polymer (polymeric material) may include water soluble and/or non-water soluble polymers. Examples of water soluble polymers include, but are not limited to, natural polymers such as starches, plant gums, modified cellulosic and lignin materials, chitan, chitosan, pectin, and water soluble and dispersible proteins. Suitable starches include corn starch, potato starch, amaranth starch, arrowroot starch, banana starch, barley starch, cassava starch, millet starch, oat starch, rice starch, rye starch, sago starch, sorghum starch, sweet potato starch, wheat starch and yam starch.

Water soluble polymers typically include polymers having one or more acidic groups per molecule, and those in which all of the acidic groups are combined as salts, or some of the acidic groups are combined as salts. The monomer system used for preparing water soluble polymers typically includes any suitable combination of olefinically unsaturated monomers which is amenable to copolymerization, provided such a monomer system includes an acid-bearing comonomer(s) (preferably in sufficient concentration to render the resulting polymer fully or partially soluble in aqueous media), or a comonomer(s) bearing an acid-forming group which yields, or is subsequently convertible to, such an acid group (such as an anhydride, e.g. methacrylic anhydride or maleic anhydride, or an acid chloride) and also a comonomer(s) which imparts crosslinkability. Typically the acid-bearing comonomers are carboxyl-functional acrylic monomers or other ethylenically unsaturated carboxyl bearing monomers such as acrylic acid, methacrylic acid, itaconic acid and fumaric acid. Sulphonic acid-bearing monomers could also e.g. be used, such as styrene p-sulphonic acid (or correspondingly styrene p-sulphonyl chloride). An acid bearing monomer could be polymerised as the free acid or as a salt, e.g. the NH₄ or alkali metal salts of ethylmethacrylate-2-sulphonic acid or 2-acrylamido-2-methylpropane sulphonic acid, or the corresponding free acids. Other, non-acid functional non-crosslinking monomer(s) which may be copolymerized with the acid monomer(s) include acrylate and methacrylate esters and styrenes; also dienes such as 1,3-butadiene and isoprene, vinyl esters such as vinyl acetate, and vinyl alkanoates. Methacrylates include normal or branched alkyl esters of C1 to C12 alcohols and methacrylic acid, such as methyl methacrylate, ethyl methacrylate, and n-butyl methacrylate, and (typically C5 to C12) cycloalkyl methacrylates acid such as isobornyl methacrylate and cyclohexyl methacrylate. Acrylates include normal and branched alkyl esters of C1 to C12 alcohols and acrylic acid, such as methyl acrylate, ethyl acrylate, n-butyl acrylate, and 2-ethylhexyl acrylate, and (typically C5-C12) cycloalkyl acrylates such as isobornyl acrylate and cyclohexylacrylate. Styrenes include styrene itself and the various substituted styrenes, such as α-methyl styrene and t-butyl styrene. Nitriles such as acrylonitrile and methacrylonitrile may also be polymerised, as well as olefinically unsaturated halides such as vinyl chloride, vinylidene chloride and vinyl fluoride. Functional monomers which impart crosslinkability (crosslinking monomers for short) include epoxy (usually glycidyl) and hydroxyalkyl (typically C1-C12, e.g. hydroxyethyl)methacrylates and acrylates, as well as keto or aldehyde functional monomers such as acrolein, methacrolein and vinyl methyl ketone, the acetoacetoxy esters of hydroxyalkyl (typically C1-C12) acrylates and methacrylates such as acetoacetoxyethyl methacrylate and acrylate, and also keto-containing amides such as diacetone acrylamide. The purpose of using such functional monomer is to provide subsequent crosslinkability in the resulting polymer system.

Water insoluble polymers that may be used to form the aerogel may include those derived from at least one emulsion polymerized hydrophobic polymer. The monomer system employed for the formation of the hydrophobic polymer may include, for example, non-acid functional monomers, and in particular styrenes, such as styrene itself, α-methylstyrene, o-, m- and p-methylstyrene, o-, m- and p-ethylstyrene, p-chlorostyrene and p-bromostyrene; normal and branched acrylic and methacrylic esters of alkanols (typically C1-C12) and cycloalkanols (typically C5-C12) such as methyl methacrylate, ethyl methacrylate, n-butyl methacrylate, t-butyl methacrylate, 2-ethylhexyl methacrylate, isobornyl methacrylate, and cyclohexyl acrylate and the corresponding acrylates; vinyl esters such as vinyl acetate and vinyl alkanoates; vinyl halides such as vinyl chloride; vinylidene halides such as vinylidene chloride; dienes such as 1,3-butadiene and isoprene. A functional monomer(s) for imparting crosslinkability (which is not normally an acid monomer) may optionally be included, examples of which include hydroxy and epoxy functional (meth)acrylates such as hydroxyalkyl (typically C1-C12) methacrylate, e.g. 2-hydroxyethyl methacrylate, glycidyl methacrylate, and the corresponding acrylates, as well as keto- and aldehyde-functional monomers such as acrolein, methacrolein, and methyl vinyl ketone, acetoacetoxy esters of hydroxyalkyl (typically C1-C12) acrylates and methacrylates such as acetoacetoxyethyl acrylate or methacrylate, and also keto or aldehyde-containing amides such as diacetone acrylamide.

Emulsifying agents that can be used for the emulsion polymerization of the water soluble polymer and/or water insoluble polymer are, for example, anionic and/or non-ionic emulsifiers. Anionic emulsifiers include, but are not limited to, alkylethoxylate sulfate and sulfonate, alkylphenolethoxylate sulfate and sulfonate, alkylsulfate and sulfonate, alkylethoxylate phosphates, alkylphenol ethoxylate phosphates, alkyl phosphates, alkylaryl sulfonates, sulfosuccinates, and mixtures thereof. Non-ionic surfactants include, but are not limited to, alkylaryl polyether alcohols, alkylphenol ethoxylates, alkyl ethoxylates, ethylene oxide block copolymers, propylene oxide block copolymers, polyethylene oxide sorbitan fatty acid esters, and mixtures thereof. In one embodiment, the amount of emulsifying agent used is between 0.3 wt % to 2 wt %, based on the weight of the total amount of monomer. In another embodiment, the amount of emulsifying agent used is between 0.3 wt % to 1 wt %.

In some embodiments, the polymer includes an epoxy. For example, in accordance with the examples set forth below, the polymer may include 1, 4-butanediol diglycidyl ether (BDGE) and triethylenetetramine (TETA). BDGE and TETA may be used as an epoxy monomer and crosslinker, respectively. As shown in FIG. 1, BDGE possesses two epoxide rings, and TETA two primary and two secondary amine groups. When mixed together, the BDGE and TETA may be crosslinked as shown. The BDGE and TETA may be provided in a suitable mole ratio (e.g., a 3:1 mole ratio) in order to form a 1:1 ratio of reactive amine protons and epoxide rings.

As included in the formed aerogel, the polymer may be present in an amount from about 5 to about 95 parts per 100 parts by weight of the aerogel. In other embodiments, the polymer may be present in an amount from about 50 to about 95 parts per 100 parts by weight of the aerogel. In other embodiments, the polymer may be present in an amount from about 70 to about 85 parts per 100 parts by weight of the aerogel.

The polymer may be combined and mixed with an aqueous (liquid) dispersion medium so as to form a suspension, dispersion, emulsion or solution. As used herein, the dispersion medium may be any suitable liquid compound or mixture of compounds that forms a crystalline phase structure when frozen and is sublimable. Examples of dispersion media include, but are not limited to, water, alcohols, such as tert-butanol, acid group containing solvents such as acetic acid, acetonitrile, dimethyl sulfoxide, cyclohexane, benzene, ortho, meta, or para-xylene, or a combination thereof. As described in the examples below, in some embodiments, the dispersion medium is water. In other embodiments, the dispersion medium may be a solvent that dissolves the polymers, copolymers, monomers, or combination thereof. For example, non-water soluble polymers may be dissolved in a suitable solvent appropriate for the polymer with examples including, but not limited to, alcohol such as methanol, ethanol, propanol, butanol, acid group containing solvents such as formic acid and acetic acid, formamide, acetone, tetrahydrofuran, methyl ethyl ketone, ethyl acetate, acetonitrile, N,N-dimethylformamide, dimethyl sulfoxide, hexane, toluene, benzene, ethers such as diethyl ether, methylene chloride, or carbon tetrachloride, etc.

The polymer may be combined and/or mixed with the dispersion medium in an amount from about 1 wt % to about 40 wt % of the total polymer/dispersion medium mixture (e.g., of the aerogel precursor). In one embodiment, the polymer is combined and/or mixed with the dispersion medium in an amount from about 1 wt % to about 20 wt % (e.g., of the aerogel precursor). In another embodiment, the polymer is combined and/or mixed with the dispersion medium in an amount from about 1 wt % to about 10 wt % (e.g., of the aerogel precursor). Higher concentrations of polymer in the solution will generally produce robust structures, but will reduce the porosity and provide for higher densities.

In some embodiments, the aerogel is free of clay. In other embodiments, the aerogel may include one or more clays that are mixed with the polymer and dispersion medium prior to freeze drying. Clay is generally defined as a material containing a hydrated silicate of an element such as aluminum, iron, magnesium, potassium, hydrated alumina, iron oxide, or the like. The silicate layers of such clays are negatively charged, and are separated by layers of positively charged ions, such as sodium, potassium and other elements. While not specifically required, naturally-occurring clays can be altered via ion exchange processes, to, for example, replace sodium ions with quaternary ammonium ions, and utilized in the aerogel. Occasionally, the clay may contain impurities of other naturally occurring minerals and elements that can vary depending on the location where the clay is obtained. The clays of interest can be used as mined, or can be purified by methods known to those of ordinary skill in the art of clay product manufacture.

In one embodiment, the clays that may be utilized in the aerogel are capable of being exfoliated or subdivided into individual layers. In another embodiment, the clays that may be utilized in the aerogel are soluble or dispersible in solvents such as water to at least 1 wt % to 5 wt %. As described in the examples, in some embodiments, the clay is montmorillonite clay. Examples of other suitable clays, include, but are not limited to, illite clays such as attapulgite, sepiolite, and allophone; smectite clays such as montmorillonite, bentonite, beidellite, nontronite, hectorite, saponite, and sauconite; kaolin clays such as kaolinite, dickite, nacrite, anauxite, and halloysite-endellite; and synthetic clays such as laponite and fluorohectorite. U.S. Patent Application Publication Nos. 2007/0208124 and 2008/0132632 are herein incorporated by reference in their entirety and are generally directed to clay aerogel polymer composites. As disclosed therein, the aerogel may be formed from day and one or more polymers such that the formed aerogel may include about 1 to about 99 wt % of day. In an embodiment only including polymer and a day in a dispersant medium; the weight ratio of polymer to day may range from 1:99 to about 99:1. In other embodiments, the clay may be present in an amount from about 1 to about 25 parts per 100 parts by weight of the aerogel. In other embodiments, the clay may be present in an amount from about 1 to about 10 parts per 100 parts by weight of the aerogel.

In some embodiments, the clays may be present in an amount ranging from about 0.25 wt % to about 15 wt % of the total weight of the polymer/dispersion medium/clay mixture (e.g., of the aerogel precursor). In one embodiment, the clays may be present in amount from about 0.25 wt % to about 10 wt % of the total weight of the polymer/dispersion medium/clay mixture (e.g., of the aerogel precursor). In another embodiment, the clays may be present in amount from about 0.25 wt % to about 5 wt % of the total weight of the polymer/dispersion medium/clay mixture (e.g., of the aerogel precursor).

In those embodiments that include a clay, a water-soluble salt may be included in the mixture prior to freeze drying. Examples of suitable water soluble salts include those comprising mono-, di-, or tri-valent cations, including, but not limited to, Na, K, Li, H, Ca, Mg, and Al; and mono-, di-, or tri-valent anions, including, but not limited to, Cl, F, Br, O, S, PO₄, SO₃, SO₄, acetate, or benzoate, or combinations thereof. These salts may be present in an amount from about 0.05 wt % to about 20 wt % of the aerogel on a dry basis, depending on the specific solubility of said salts.

Additives useful to modify the properties of the aerogel may also be included in the aerogel. For example, additives such as colorants (dyes, pigments), antistatic agents, chemical coupling agents, electrically conductive-fillers including, but not limited to, forms of conductive carbon and metal flakes/particles; and photoactive species including, but not limited to, rare earth ions, may each be incorporated into the aerogel structures. In one embodiment, the additives may be included in an amount less than about 1 wt % of the aerogel structure. In another embodiment, the additives may be included in an amount less than about 0.1 wt %.

Filler such as, but not limited to, non-smectic clays, talc, mica, fluoromica, glass fibers, carbon fibers, and carbon nanotubes may also be incorporated in an amount up to about 50 wt % of the aerogel or aerogel component on a dry basis. In one embodiment, the filler may be included in an amount less than about 10 wt % of the aerogel. The amount of filler will depend on the particular aerogel composition.

In one embodiment, the aerogel includes one or more same or different fibers. The fibers may serve as a reinforcing agent that improves the structural integrity of the aerogels, and in some embodiments, may serve as a wicking material and aid in the uptake of fluid to the aerogel.

Fibers are generally threads or thread-like structures in discrete elongated pieces. Suitable fibers include both natural fibers and synthetic fibers. Natural fibers are those produced by plants, animals, or geological processes. For example, plant fibers include, but are not limited to, cotton, hemp, jute, flax, ramie and sisal. Wood fibers derived from tree sources are also included within the scope of the present disclosure, including processed and unprocessed wood fibers. Animal fibers generally consist of proteins such as, but not limited to, spider silk, sinew, catgut, wool and hair such as cashmere, tunicate whiskers, mohair and angora. Mineral fibers are derived from naturally occurring minerals and include for example asbestos, woolastinite, attapulgite and halloysite. Synthetic fibers can be formed from natural or synthetic materials. Glass fibers are an example and can be made as a further example from natural raw materials such as quartz. Metal or metal oxide fibers are also suitable and can, for example, be drawn from ductile metals such as copper, gold or silver, and extruded or deposited from metals considered brittle such as nickel, aluminum or iron, for example. Carbon fibers are often based on carbonized polymers. Polymer fibers can be made from any suitable polymer including, but not limited to, polyamides, polyesters, polyolefins, polyethers, polyurethanes, polyalcohols, polyelectrolytes, polyvinyl alcohol, polyacrylonitrile and polyvinyl chloride. Fibers also include coextruded fibers having two distinct polymers forming the fiber, such as a core-sheath fiber or side-by-side fiber. Fibers also can be coated if desired. For example, coated fibers exist such as nickel-coated fibers in order to provide static elimination, silver-coated to provide anti-bacterial properties, and aluminum-coated fibers. Industrial made fibers from natural materials include soy-based fibers known as SOYSILK®, and corn-based fibers such as INGEO®. In some embodiments, various fibers present in an aerogel component that is fired, such as some polymeric fibers, can carbonize and form an interpenetrating network of carbon fibers and ceramic structures.

As described above, one or more tannins may be incorporated into the aerogel. Tannins are a family of natural polyphenol materials, found for example in a number of plants, which contain multiple adjacent, chemically-reactive phenolic hydroxyl groups. In one example, tannins may be found in high concentrations within the bark of trees. The barks of trees including tannins may maximize char yields when exposed to fire, forming graphitic carbon layers during the burning event. Graphitic carbon layers are very poor heat conductors, assisting with the survival of trees during forest fires. In accordance with the present disclosure, it was found that tannin can act as a charring agent for the aerogel. Char formation can be enhanced and formation of a protective layer against the heat of the flame and diffusion to the flame of combustible volatile compounds can result, thereby decreasing polymer volatilization. It was also found that tannin can interact with the polymer and/or clay of the aerogel, thereby promoting the crosslinking of the formed aerogel structure.

In embodiments where the one or more tannins is incorporated into the aerogel precursor during formation of the aerogel, the one or more tannins may be included in an amount less than about 10 wt % of the aerogel precursor (e.g., about 0.25 wt % to about 10 wt %). In another embodiment where the one or more tannins are incorporated into the aerogel precursor during formation of the aerogel, the one or more tannins may be included in an amount less than about 5 wt % of the aerogel precursor (e.g., about 0.25 wt % to about 5 wt %). In another embodiment where the one or more tannins are incorporated into the aerogel precursor during formation of the aerogel, the one or more tannins may be included in an amount less than about 2.5 wt % of the aerogel precursor (e.g., about 0.25 wt % to about 2.5 wt %). Increasing the tannin concentration in the aerogel precursor to beyond an acceptable amount may have a negative effect on the mechanical properties of the aerogel (e.g., due to excessive crosslinking).

As included in the formed aerogel, the tannin may be present in an amount from about 1 to about 20 parts per 100 parts by weight of the aerogel. In other embodiments, the tannin may be present in an amount from about 1 to about 15 parts per 100 parts by weight of the aerogel. In other embodiments, the tannin may be present in an amount from about 1 to about 10 parts per 100 parts by weight of the aerogel.

In accordance with the examples set forth below, in some embodiments, the tannin incorporated into the aerogel and/or coated on the aerogel is tannic acid (TA), C₇₆H₅₂O₄₆. In other embodiments, one or more other tannins may be used in addition or as an alternative to TA. Examples of other tannins include suitable hydrolysable tannins such as gallic acid and ellagic acid; condensed tannins; and phlorotannins.

TA can strongly interact with clay platelets by hydrogen bonding between phenolic hydroxyl groups of the TA and hydroxyl groups of the clay, and can also have electrostatic interactions with the polymer. In accordance with the examples set forth below, incorporating 2 wt % TA in the aerogel precursor was found to increase the crosslink density of the aerogel. In the examples where the polymer included in the aerogel precursor is BDGE-TETA and the aerogel precursor further includes a clay, the phenolic hydroxyl groups of TA may interact with the clay platelets by hydrogen bonding and with the BDGE-TETA molecular chains by electrostatic interaction, forming the network crosslink structure.

The aerogels in accordance with the present application may be formed by subjecting an aerogel precursor (e.g., the mixture of polymer, dispersant medium, and optionally, one or more clays, fillers, additives, etc.) to a freeze drying procedure. The freeze drying procedure causes the liquid component of the dispersion to be removed while leaving the solid structure of the aerogel intact.

In the case of the formation of a polymer aerogel, a polymer, copolymer, monomer, or combination thereof may be combined with a sufficient amount of a dispersion medium to form a mixture. If clay and/or one or more of additives is to be included in the polymer aerogel, such additives may be combined and/or mixed with the polymer at any period of time prior to addition of the polymer to the dispersion medium, at a time subsequent the combination of the polymer and dispersion medium, or at both times.

The aerogel precursor is mixed for a period of time generally until the polymer is suspended or dissolved in the dispersion medium. Mixing may be performed by any suitable means, such as blending and shearing, for any suitable period of time until desired suspension is achieved. For example, the duration of the mixing process may range from about 1 minute to about 120 minutes, and the mixing process may yield a homogeneous or substantially homogenous mixture. In one embodiment, the dispersion medium may be heated to increase solubility of the polymer and/or additives.

The mixture may be poured or otherwise transferred into any desired structure that serves as a mold. Although in some embodiments the aerogel precursor may be mixed in the mold.

The aerogel precursor is subsequently frozen, for example in a solid carbon dioxide and ethanol bath. In another embodiment, the mixture is frozen utilizing liquid nitrogen, although the liquid nitrogen does not contact the mixture. Generally the dispersion medium forms a crystalline phase when frozen. In general, crystal growth of the dispersion medium will contribute to the formation of the aerogel structure. In one embodiment, the aerogel precursor is subjected to temperatures within the range of about −1° C. to about −196° C. In another embodiment, the aerogel precursor is subjected to temperatures within the range of about −40° C. to about −196° C. In yet another embodiment, the aerogel precursor is subjected to temperatures within the range of about −60° C. to about −100° C. In one embodiment, the aerogel precursor is subjected to temperatures of about −60° C. In another embodiment, the aerogel precursor is subject to temperatures of about −10° C.

In those embodiments where only a polymer is included in the dispersion medium, the binding forces of the polymer will maintain the formed structure. Subsequently, the frozen mixture is dried under vacuum (i.e., freeze-dried) and the dispersion medium is sublimed. The formed aerogel may then be removed from the mold.

The aerogel may optionally be oven cured while under vacuum, either prior to or subsequent to the aerogel being removed from the mold. In the curing process, the aerogels may be heated to a temperature ranging from about 150° C. to about 1200° C. for any suitable period of time. The cured aerogel structures have low density, are mechanically resilient, easily handled, and stable to high temperatures of use.

In some embodiments, the aerogel may be formed as a tannin-modified aerogel (e.g., via internal addition of the tannins to the aerogel precursor). In such embodiments, the tannin may be combined with the one or more polymers (e.g., polymer, copolymer, and/or monomer) and the dispersion medium to form the aerogel precursor. If clay and/or one or more of additives is to be included in the aerogel, such components may also be added to the aerogel precursor. The aerogel precursor including the tannin may be mixed, frozen and freeze dried as described above, to produce a tannin-modified aerogel material.

In some embodiments, the aerogel may be coated with a tannin-containing coating solution. The aerogel being coated with the tannin-containing coating solution may be an aerogel that does not include tannin (e.g., an aerogel that was not formed as a tannin-modified aerogel); or may be a tannin-modified aerogel (e.g., an aerogel to which tannin was added to the aerogel precursor).

By coating, a solution or dispersion of the tannin may be applied to the formed aerogel by a process such as immersing and soaking the aerogel, spraying the aerogel, painting the aerogel, or other suitable methods of applying a coating to a solid substrate. In those embodiments where the aerogel is coated by soaking the aerogel, the soaking (coating) process may be conducted for any suitable amount of time. In some examples, the duration of the soaking (coating) process may be up to one week (7 days). In other examples, the duration of the soaking (coating) process may be up to two days (48 hours). In other examples, the duration of the soaking (coating) process may be up to one day (24 hours). In other examples, the duration of the soaking (coating) process may be up to one hour.

A variety of coating dispersion mediums can be used for dispersing and/or dissolving the tannins therein. A suitable coating dispersion medium that does not dissolve or destroy the aerogel may be chosen. In some embodiments, ethanol is used as the coating dispersion medium for the coating solution. In other embodiments, the dispersion medium for the coating solution may be any suitable liquid compound or mixture of compounds. Examples of dispersion media include, but are not limited to, water, alcohols (e.g., methanol, ethanol, propanol, butanol), acid group containing solvents such as formic acid and acetic acid, formamide, acetone, tetrahydrofuran, methyl ethyl ketone, ethyl acetate, acetonitrile, N,N-dimethylformamide, dimethyl sulfoxide, cyclohexane, toluene, benzene, ortho, meta, or para-xylene, ethers such as diethyl ether, methylene chloride, or carbon tetrachloride, or a combination of one or more thereof.

To form the tannin-containing coating solution, the tannins may be combined with a sufficient amount of a dispersion medium to form a mixture, and mixed for a period of time generally until the tannins are suspended or dissolved in the dispersion medium. Mixing may be performed by any suitable means, such as blending and shearing, for any suitable period of time until desired suspension is achieved. For example, the duration of the mixing process may range from about 1 minute to about 120 minutes, and the mixing process may yield a homogeneous or substantially homogenous mixture. In one embodiment, the dispersion medium may be heated to increase solubility of the polymer and/or additives.

In one example, the tannin is provided in the tannin-containing coating solution in an amount less than about 10 wt % of the coating solution (e.g., about 0.25 wt % to about 10 wt %). In another example, the tannin is provided in the tannin-containing coating solution in an amount less than about 5 wt % of the coating solution (e.g., about 0.25 wt % to about 5 wt %). In another example, the tannin is provided in the tannin-containing coating solution in an amount less than about 2.5 wt % of the coating solution (e.g., about 0.25 wt % to about 5 wt %).

As described above, the tannin may crosslink with the polymer and the clay. The coated aerogels are porous materials and present a high specific surface area which allow the tannin in the coating solution to penetrate into the aerogel during the coating process. In the examples set forth below where the polymer included in the aerogel is BDGE-TETA, the aerogel further includes a clay, and the tannin included in the tannin-containing coating solution is TA, the phenolic hydroxyl groups of the TA could interact with the clay platelets by hydrogen bonding and with the BDGE-TETA molecular chains by electrostatic interaction, forming a network crosslink structure.

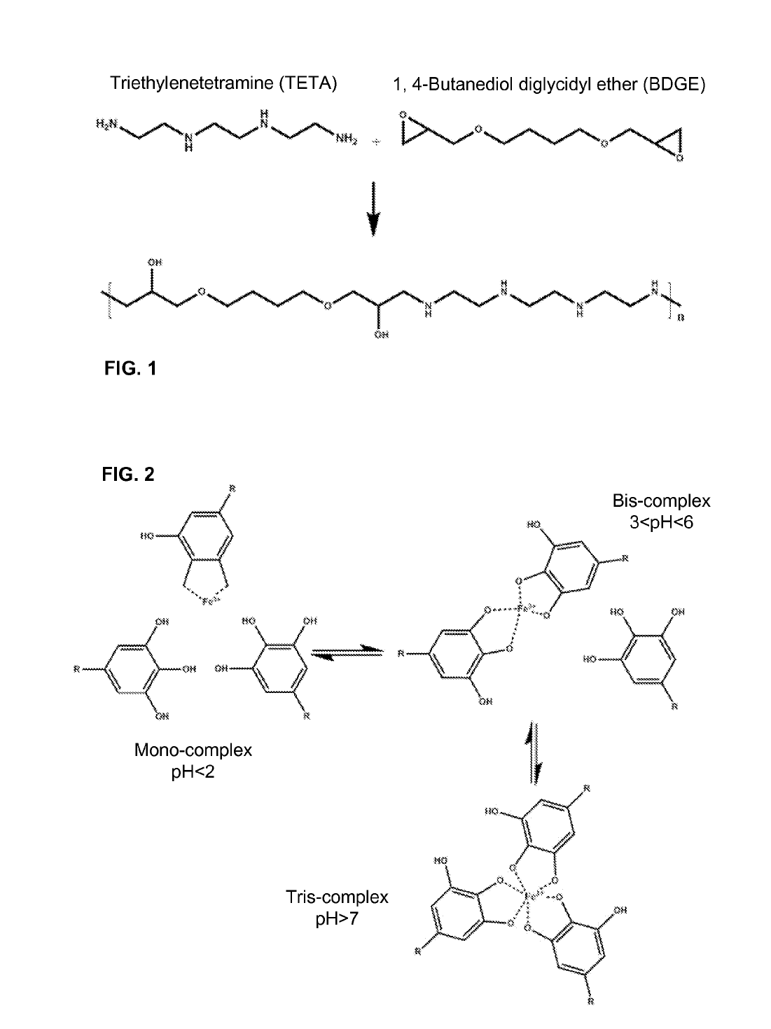

In some embodiments, the tannin-containing coating solution includes a source of ferric iron (Fe(III)). Exemplary sources of ferric iron include FeCl₃ and Fe₂(SO₄)₃. Tannins show specific affinity to metal ions, such as pH-responsive complexes with ferric ions. FIG. 2 exemplifies the pH-responsive complexes that may be formed between TA and Fe(III) ions. As shown, mono-complexes of the TA and the Fe(III) ions may be present at a low pH (e.g., below 2). Bis-complexes of the TA and the Fe(III) ions may form at the pH range of about 3 to about 6. Tris-complexes of the TA and the Fe(III) ions may form at the pH range of greater than about 7.

The complexes of the tannins and the Fe(III) ions may be present in the coating solution for coating the surface of aerogel composites. The complexes of the tannins and the Fe(III) ions may be also be formed in the aerogel structure (e.g., upon coating a tannin-modified aerogel with the coating solution including the Fe(III) ions). The coordination complexes have been found to provide an effect on the coated aerogel. As exemplified in the examples described below, such coordination complexes have surprisingly been found to substantially improve the mechanical properties of tannin-modified polymer aerogels.

In one example, the source of ferric iron included in the coating solution may be between about 0.01-0.5 mg/mL. In another example, the source of ferric iron included in the coating solution may be between about 0.05-0.3 mg/mL. In another example, the source of ferric iron included in the coating solution may be between about 0.06-0.2 mg/mL. The source of ferric iron may be combined and mixed with the tannins and dispersion medium when forming the tannin-containing coating.

In one example, the ferric iron is provided in the tannin-containing coating solution in an amount less than about 0.1 wt % of the coating solution (e.g., about 0.001 wt % to about 0.1 wt %). In another example, the ferric iron is provided in the tannin-containing coating solution in an amount less than about 0.05 wt % of the coating solution (e.g., about 0.001 wt % to about 0.05 wt %). In another example, the ferric iron is provided in the tannin-containing coating solution in an amount less than about 0.025 wt % of the coating solution (e.g., about 0.001 wt % to about 0.025 wt %).

Numerous different articles can be prepared containing the aerogel material, and may be used, for example, in packaging, insulation, and structural applications. Examples of such articles include, but are not limited to, small, free-flowing particles (typically, but not limited to, about 1 to about 3 inches in length, and of many different shapes) suitable for use as a packaging material; single molded parts or forms suitable for packaging of electronic components and other items similar to and as a replacement for the polystyrene foam inserts; molded parts, organized bats or free-flowing particles suitable for thermal and/or acoustical insulation, including, but not limited to, housing (walls, attic, roofing structures, pipes and ductwork), vehicles such as sound deadening panels or foams, and aircraft and spacecraft exterior and interior insulation panels; articles suitable for providing barrier to gas or liquid permeation; articles suitable for providing ballistic protection, suitable for use in individual body armor, as well has vehicular protection in land, water, or aeronautic forms of transportation; filters or products (pads, bats, and loose fills, etc.) used to absorb industrial, biological, chemical, agricultural wastes and other fluids.

Embodiments of inventive compositions and methods are illustrated in the following examples. These examples are provided for illustrative purposes and are not considered limitations on the scope of inventive compositions and methods.

### Examples

### Aerogel Production:

Aerogel samples were prepared by combining and mixing the compounds set forth in Table 1, reproduced below, to form an aerogel precursor. The aerogel samples were subsequently transferred into molds, frozen, and freeze dried.

TABLE 1
Aerogel Samples

| | DI water | Clay | BDGE | TETA | Tannic Acid |
|---|---|---|---|---|---|
| Sample | (mL) | (g) | (g) | (g) | (g) |
| E20C5 | 100 | 5 | 16.115 | 3.885 | 0 |
| E20C5T2 | 100 | 5 | 16.115 | 3.885 | 2 |

More specifically, aerogel sample E20C5 was produced from an aerogel precursor containing 20 wt % BDGE-TETA and 5 wt % clay. It is noted that such percentages are given as percentages of the aerogel precursor prior to freeze drying. In accordance with the aerogel precursor preparation, 5.0 g sodium montmorillonite clay (PGW grade, cation exchange capacity (CEO) 145 meq/100 g; Nanocor Inc., Arlington Heights Ill. USA) was combined with 50 mL deionized (DI) water (obtained using a Barnstead ROpure low-pressure, reverse-osmosis system) in a Waring (Chula Vista Calif. USA) model MC2 mini laboratory blender for approximately 1 minute to prepare a clay suspension. In a 100 mL flask, 25.0 mL of DI water and 20.145 g of BDGE (Momentive, Houston, Tex. USA) were added to prepare a BDGE solution. In a second 100 mL flask, 25.0 mL of DI water and 4.855 g of TETA (EPIKURE Curing Agent 3232, Momentive, Houston, Tex. USA) were combined to prepare a TETA solution. The respective mole ratios of BDGE and TETA were 3:1. The clay suspension, the BDGE solution, and the TETA solution were combined and stirred until the solutions were homogenous without any visible bubbles.

The resulting aerogel precursor was poured into cylindrical molds having a 20 mm inner diameter and frozen within a solid carbon dioxane/ethanol bath. The resulting aerogel precursor was also poured into 100 mm×100 mm×10 mm rectangular molds and frozen within a solid carbon dioxane/ethanol bath. The frozen samples were dried in a VirTis AdVantange® freeze dryer (Warminster, Pa. USA), wherein the ice inside the samples was sublimed under high vacuum. The freeze drying process was conducted for a period of 3 days to ensure complete removal of the ice from the samples.

Aerogel sample E20C5T2 (tannin-modified aerogel) was produced from an aerogel precursor containing 20 wt % BDGE-TETA, 5 wt % clay, and 2 wt % TA. The aerogel precursor for the E20C5T2 aerogel sample was produced in a similar manner as described above with respect to sample E20C5, but 2.0 g of TA was combined together with the clay suspension, the BDGE solution, and the TETA solution to form the aerogel precursor. The aerogel precursor was stirred until the solutions were homogenous without any visible bubbles. The resulting aerogel precursor was poured into cylindrical, 20 mm inner diameter polystyrene vials and frozen within a solid carbon dioxane/ethanol bath. The resulting aerogel precursor was also poured into 100 mm×100 mm×10 mm rectangular molds and frozen within a solid carbon dioxane/ethanol bath. The frozen samples were dried in a VirTis AdVantange® freeze dryer (Warminster, Pa. USA), wherein the ice inside the samples was sublimed under high vacuum. The freeze drying process was conducted for a period of 3 days to ensure complete removal of the ice.

### Aerogel Coating:

Some of the E20C5 and E20C5T2 aerogel samples produced in accordance with the exemplary production method were subsequently coated with a tannin-containing coating solution. To form the tannin-containing coating solution, TA was dissolved in ethanol. In a 500 mL flask, 6.0 g TA was dissolved with 200 mL ethanol. Stirring force was applied to the solution for 5 minutes in order to dissolve TA in the ethanol. As combined, the tannin-containing coating solution was a 2 wt % TA solution.

Some of the E20C5 and E20C5T2 aerogel samples produced in accordance with the exemplary production method were subsequently coated with a tannin-containing coating solution including ferric iron (Fe(III) ions). To form the coating including both TA and ferric iron, 0.06 g FeCl₃.6H₂O (iron(III) chloride hexahydrate −97%, Sigma-Aldrich, St Louis, Mo. USA) was combined with 50 mL ethanol in another 100 ml flask to prepare a ferric solution. Stirring force was applied to the solution for 5 minutes. In a 500 mL flask, 6.0 g TA was dissolved with 200 mL ethanol. Stirring force was applied to the solution for 5 minutes in order to dissolve TA in the ethanol. The ferric solution was mixed together with the TA solution. As combined, the tannin-containing coating solution including ferric iron included a concentration of 0.2 mg/ml FeCl₃.6H₂O, which yielded a 0.02 wt % ferric and 2 wt % TA coating solution. A 50 mL Sodium hydroxide (Fisher, Pittsburgh, Pa., USA) solution with DI water was prepared to adjust the pH value of the tannin-containing coating solution including ferric iron to above 7.

Some of the E20C5 and E20C5T2 aerogel samples produced in accordance with the exemplary production method were subsequently immersed in ethanol. The samples immersed in ethanol served as a control for compression testing.

Coating of the E20C5 and E20C5T2 aerogel samples produced in accordance with the exemplary production method was performed for each of the (1) 2 wt % TA solution with ethanol as solvent, (2) 2 wt % TA 0.02% ferric ion solution with ethanol as solvent, and (3) ethanol control. For each coating process, E20C5 and E20C5T2 aerogel samples produced in accordance with the exemplary production method were submerged into the coating solution. After 48 hours, the samples were placed in a solid carbon dioxide/ethanol bath to freeze. The frozen samples were then put in the freeze dryer for 3 days to completely remove the ethanol from the coating.

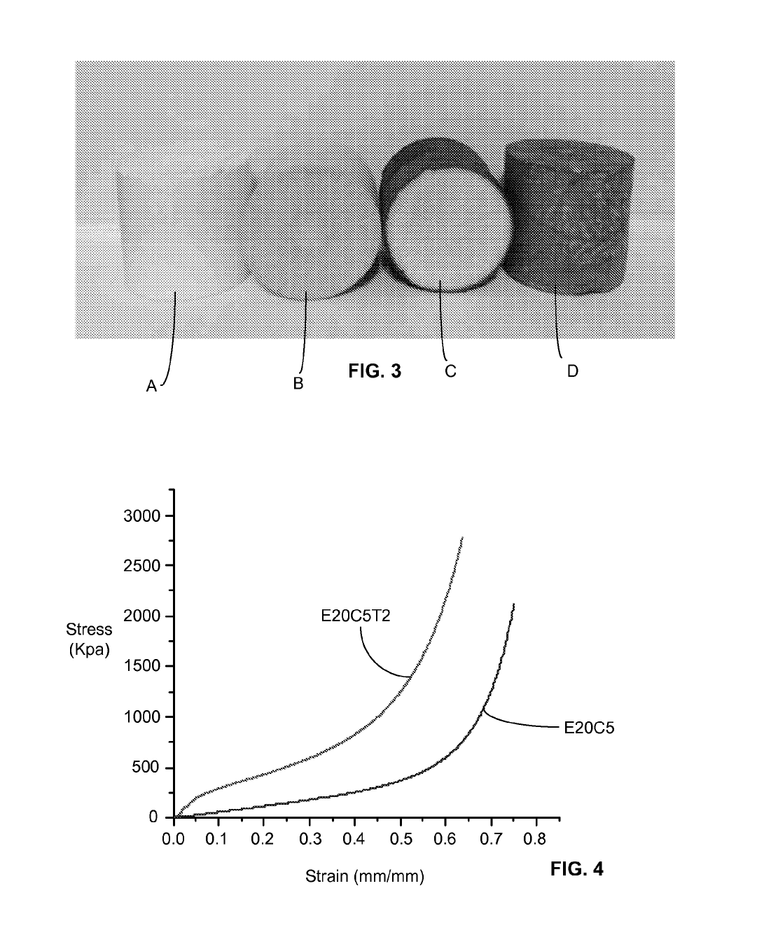

FIG. 3 shows exemplary E20C5 and E20C5T2 aerogel samples produced in accordance with the exemplary production method. Sample A shows an E20C5 sample that was not coated. Sample B shows an E20C5T2 aerogel sample that was not coated. Sample B shows slight coloring as compared with Sample A. Samples C and D each show an E20C5T2 aerogel sample that was coated with the tannin-containing coating solution including ferric iron (2 wt % TA and 0.02 wt % ferric). In samples C and D, a purple colored outer layer was produced on the surface of the aerogel.

### Compression Testing:

Coated and uncoated E20C5 and E20C5T2 aerogel samples were subjected to compression testing. For mechanical testing, cylindrical test pieces were cut from the samples formed in the cylindrical mold to have a size of 20 mm in height and 20 mm in diameter. Compression testing was conducted on the test pieces using an Instron model 5500 universal testing machine, fitted with a 1 kN load cell. These tests were performed at a constant strain rate of 1.00 mm/min and were stopped when the 1 kN load limit was reached. Five samples for each composition were tested for reproducibility and statistical variation.

FIG. 4 shows the compressive stress-strain curves of the uncoated E20C5 and E20C5T2 aerogel samples. For the uncoated E20C5 aerogel sample, the majority of the stress-strain curve exhibits classic foam behavior, with an elastic region at low strain followed by compaction with increasing compressive strain. The uncoated E20C5 aerogel samples were found to be highly deformable and flexible, with the ability to recover over 95% of their original shape after yielding (at 70% compressive strain). The compressive modulus (M), density (d), and specific modulus (M/d) of the uncoated E20C5 aerogel sample are set forth in Table 2, below.

The uncoated E20C5T2 aerogel sample was stiffer by comparison, with the compressive behavior changing significantly due to the incorporation of 2 wt % tannin (due to increased crosslinking). However, the ductility of the uncoated E20C5T2 aerogel sample decreased with the increased crosslinking. These samples were not as flexible as the uncoated E20C5 aerogel samples and were unable to recover from significant deformation to their original shapes after yielding. The compressive modulus (M), density (d), and specific modulus (M/d) of the uncoated E20C5T2 aerogel sample are set forth in Table 2, below.

TABLE 2
Mechanical properties of aerogels

| Sample | M | d | M/d |
|---|---|---|---|
| E20C5 | 0.5 ± 0.1 | 0.23 ± 0.005 | 2.3 ± 0.2 |
| E20C5T2 | 4 ± 1 | 0.25 ± 0.003 | 16 ± 4 |

Modulus (M) in MPa, density (d) in g/cm³, specific modulus (M/d) in MPa cm³/g.

As shown in Table 2, the presence of the 2 wt % TA raises the density of the aerogel slightly (as compared with the aerogel that does not include the 2 wt % TA). The presence of the 2 wt % TA also increases the viscosity of the precursor solution. Under higher viscosity conditions, the growth rate of ice crystals slows during the freezing process, producing smaller ice crystals and reducing the volumetric expansion of the aerogel. Accordingly, as shown in Table 2, the compressive modulus of E20C5T2 increased significantly. The change in specific modulus indicates that the enhancement of the mechanical properties of E20C5T2 aerogel can be attributed to structure beyond merely increasing densities. TA can strongly interact with clay platelets by hydrogen bonding between phenolic hydroxyl groups of TA and hydroxyl groups of clay, and can also have electrostatic interactions with the BDGE-TETA molecular chains. Incorporating the 2 wt % TA increased the crosslink density of the aerogel. Fewer defects were formed through E20C5T2 compared to E20C5, which produced structures with higher compressive moduli.

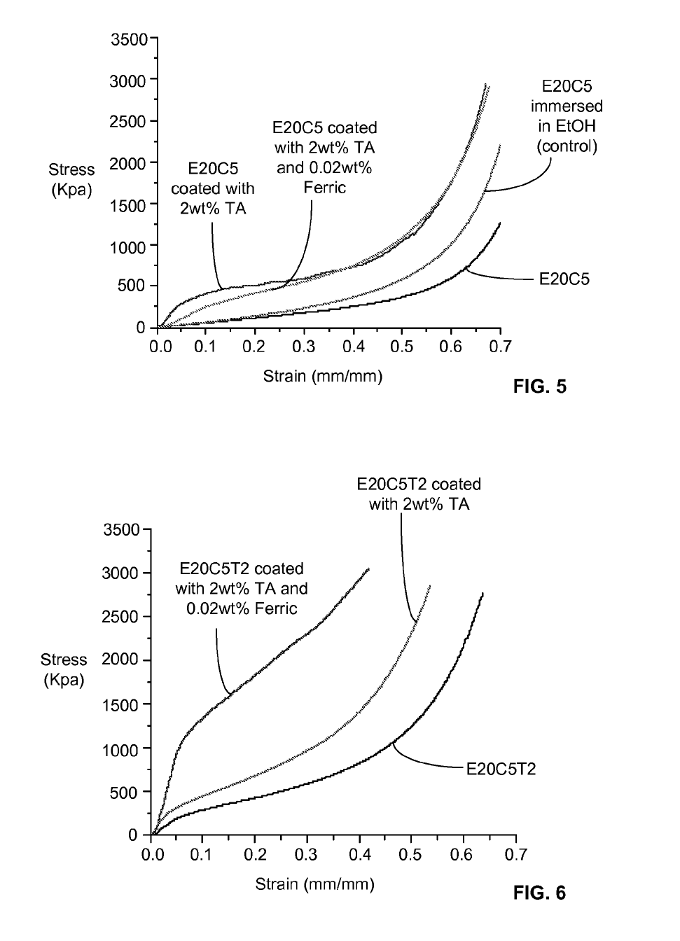

FIG. 5 shows the compressive stress-strain curves of the uncoated E20C5 aerogel sample as compared with the coated E20C5 aerogel samples. The compressive behavior of the ethanol coated (control) E20C5 aerogel sample was slightly increased compared with the uncoated E20C5 aerogel sample. As further shown in FIG. 5, the compressive behavior of both the E20C5 aerogel sample coated with the 2 wt % TA coating solution and the E20C5 aerogel sample coated with the 2 wt % TA and 0.02 wt % ferric coating solution were significantly increased as compared with the uncoated E20C5 aerogel sample, but showed similar compressive behavior with respect to each other (regardless of the presence/absence of the ferric). The compressive modulus (M), density (d), and specific modulus (M/d) of the coated E20C5 aerogel samples are set forth in Table 3, below.

As shown in Table 3, after coating the E20C5 sample with the 2 wt % TA coating solution and with the 2 wt % TA and 0.02 wt % ferric coating solution, respectively, the compressive modulus of E20C5 increased without significantly increasing bulk densities. The specific moduli rose significantly of these samples also rose significantly as compared with the non-coated E20C5. Although not specifically listed in Table 3, it is noted that the mechanical properties of the E20C5 samples coated with pure ethanol were almost the same as with E20C5, ruling out the possibility that the enhancement of compressive moduli of the coated E20C5 samples was attributable to the ethanol.

TABLE 3
Mechanical properties of aerogels after coating

| Sample | M | d | M/d |
|---|---|---|---|
| E20C5 coated with 2 wt % TA | 6 ± 2 | 0.26 ± 0.003 | 23 ± 8 |
| E20C5 coated with 2 wt % TA | 2.5 ± 0.3 | 0.27 ± 0.003 | 9 ± 1 |
| and 0.02 wt % ferric | | | |
| E20C5T2 coated with 2 wt % TA | 10 ± 2 | 0.27 ± 0.006 | 40 ± 7 |
| E20C5T2 coated with 2 wt % TA | 22 ± 3 | 0.27 ± 0.005 | 82 ± 11 |
| and 0.02 wt % ferric | | | |

Modulus (M) in MPa, density (d) in g/cm³, specific modulus (M/d) in MPa cm³/g.

FIG. 6 shows the compressive stress-strain curves of the uncoated E20C5T2 aerogel sample as compared with the coated E20C5T2 aerogel samples. The compressive behavior of the E20C5T2 aerogel sample coated with the 2 wt % TA coating solution and the E20C5T2 aerogel sample coated with the 2 wt % TA and 0.02 wt % ferric coating solution both increased as compared with the uncoated E20C5T2 aerogel sample. In addition, the compressive behavior of the E20C5T2 aerogel sample coated with the 2 wt % TA and 0.02 wt % ferric coating solution changed noticeably as compared with the compressive behavior of the E20C5T2 aerogel sample coated with the 2 wt % TA coating solution. This is contrasted with the negligible effect that the ferric had when used in connection with the coating for the E20C5 sample. The compressive modulus (M), density (d), and specific modulus (M/d) of the coated E20C5T2 aerogel samples are set forth in Table 3, above.

The enhancement of properties by the ferric ions in connection with the E20C5T2 aerogel sample is understood to come from coordination reactions, as ferric ions can form complexes with TA. During the coating process, ferric ions can penetrate into the E20C5T2 and coordinate with TA inside the E20C5T2, linking the TA inside aerogel and in the solution together. Metal-ligand complex were introduced into the structure of E20C5T2 in this way. As E20C5 has no TA internally, coating with ferric ions did not make as significant of a difference for mechanical property.

### SEM

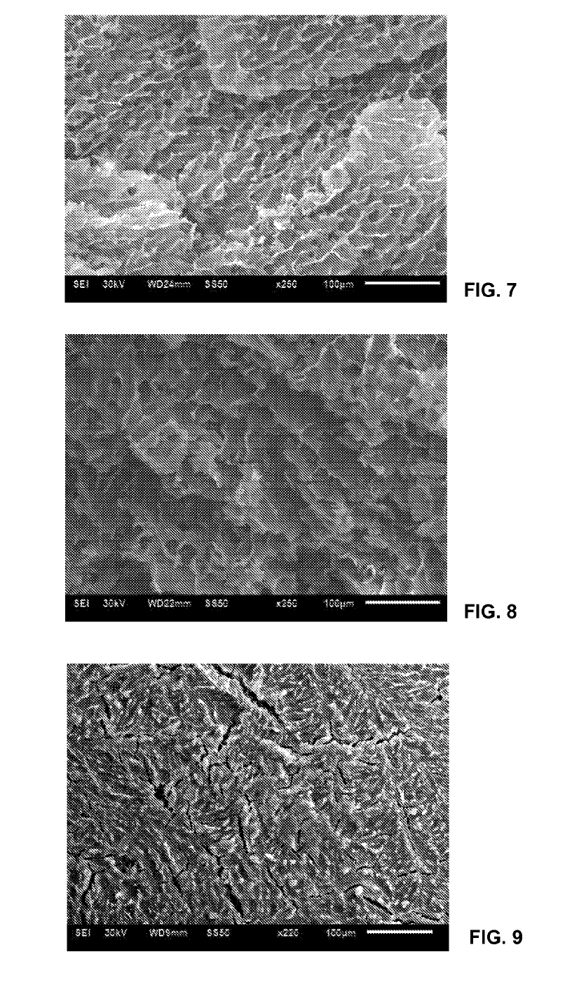

Morphology studies of the coated and uncoated E20C5 and E20C5T2 aerogel samples were conducted using SEM. The samples were imaged using a Phillips model XL-30 ESEM scanning electron microscope equipped with an energy-dispersive X-ray (EDX) spectrometer. Corresponding micrographs of the aerogel composites are displayed in FIGS. 7-12.

Previous studies indicate that for epoxy aerogel produced from BDGE-TETA, clay surfaces are completely covered with BDGE-TETA polymer. As shown in FIG. 7 (uncoated E20C5 aerogel sample), the sample includes a house-of-cards structure that is characteristic of clay aerogels. The BDGE-TETA structure could partly interact with the clay platelets by hydrogen bond forming a three-dimensional polymer/clay network.

As shown in FIG. 8, upon incorporation of 2 wt % of TA into the aerogel precursor (uncoated E20C5T2 aerogel sample), the polymer/clay network becomes further crosslinked because TA has a strong interaction with clay platelets and BDGE-TETA chains through hydrogen bonding and electrostatic interaction. It is noted that the addition of TA increases the viscosity of the precursor solution, which made BDGE-TETA molecular chains and clay platelets less mobile and decrease the ability to rearrange, thereby producing a random structure with a high crosslink density compared to the E20C5 aerogel sample. This structural change could play a role in enhancing the mechanical properties as discussed above.

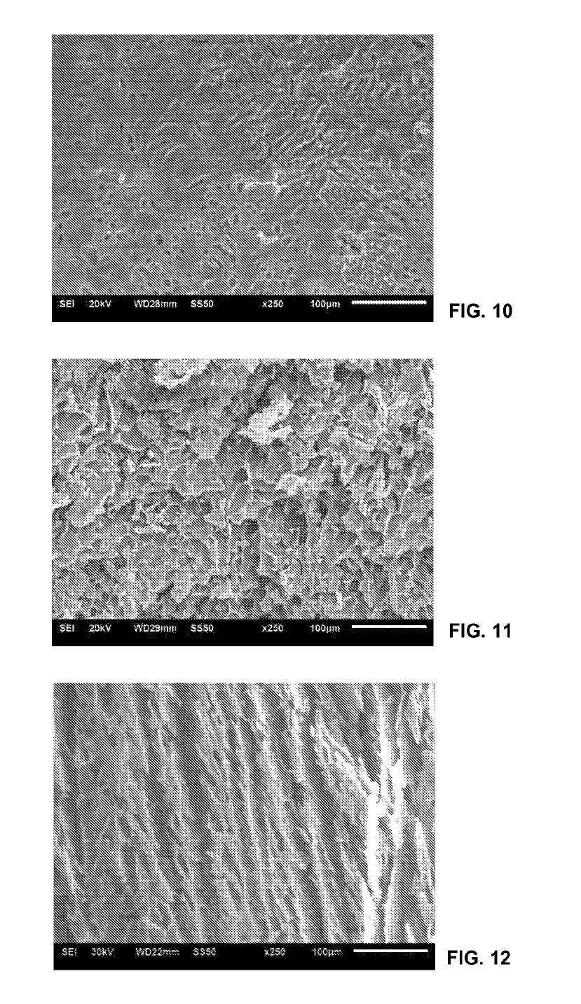

FIG. 9 shows the surface of an E20C5 aerogel sample coated with the 2 wt % TA and 0.02 wt % ferric coating solution. FIG. 10 shows the surface of an E20C5T2 aerogel sample coated with the 2 wt % TA and 0.02 wt % ferric coating solution. These samples each include a stiff layer on the surface of the aerogels. These layers were formed from TA complex with ferric ions in the solution and adsorbed to the surface of aerogel.

As discussed above, coating with ferric ions can introduce ionic bonding in the E20C5T2 aerogel sample by coordinating with TA, which can change the aerogel structure to a finer grained network structure and can further enhance the mechanical properties of E20C5T2. FIG. 11 shows layers of the E20C5 aerogel sample coated with the 2 wt % TA and 0.02 wt % ferric coating solution. FIG. 12 shows layers of the E20C5T2 aerogel sample coated with the 2 wt % TA and 0.02 wt % ferric coating solution.

### Flammability Testing:

Coated and uncoated E20C5 and E20C5T2 samples were subjected to flammability testing. For flammability testing, rectangular test pieces formed from the 100 mm×100 mm×10 mm rectangular molds were used. The combustion behavior of the aerogel samples was studied by cone calorimetry, which may be used for predicting combustion behavior under real fire conditions. Cone calorimetry is a bench-scale testing that can be used to quantitatively analyze the flammability and modeling the real-world fire conditions. The relative flammability data of the aerogel samples before and after coating, such as peak of heat release rate (PHRR), time to ignition (TTI), total heat release (THR), time to peak of heat release rate (TTPHRR), and fire growth rate (FIGRA) can be used to evaluate their flammability. The burning behaviors of aerogels were tested with a Fire Testing Technology calorimeter operating according to ISO 5660-1. The specimens were tested in a frame, under a heat flux of 50 kW/m². Limiting oxygen index (LOI) tests were also performed at room temperature according to ASTM D2863-97 using a HC-2C oxygen index instrument to determine the minimum concentration of oxygen, expressed as a percentage, which will support combustion of the sample. The detailed cone calorimetry and LOI data for the aerogel samples are summarized in Table 4.

TABLE 4
Burning parameters of aerogels (coated and uncoated)

| | TTI | PHRR | THR | TTPHRR | FIGRA | Residue | LOI |
|---|---|---|---|---|---|---|---|
| Sample | (S) | (kW/m²) | (MJ/m²) | (s) | (W/s) | (%) | (%) |
| E20C5 | 6 ± 0.6 | 407 ± 7 | 47 ± 1 | 160 ± 7 | 2.5 ± 0.2 | 18.5 ± 0.1 | 19 |
| Coated | 3 ± 0.6 | 335 ± 8 | 61 ± 4 | 175 ± 5 | 1.9 ± 0.2 | 22.5 ± 0.3 | 21 |
| E20C5 | | | | | | | |
| E20C5T2 | 7 ± 0.6 | 370 ± 15 | 51 ± 2 | 165 ± 10 | 2.2 ± 0.5 | 21.1 ± 0.1 | 20 |
| Coated | 3 ± 0.6 | 319 ± 10 | 62 ± 2 | 185 ± 7 | 1.7 ± 0.3 | 21.6 ± 0.4 | 21 |
| E20C5T2 | | | | | | | |

Coating solution is 2 wt % TA 0.02 wt % ferric with ethanol as solvent

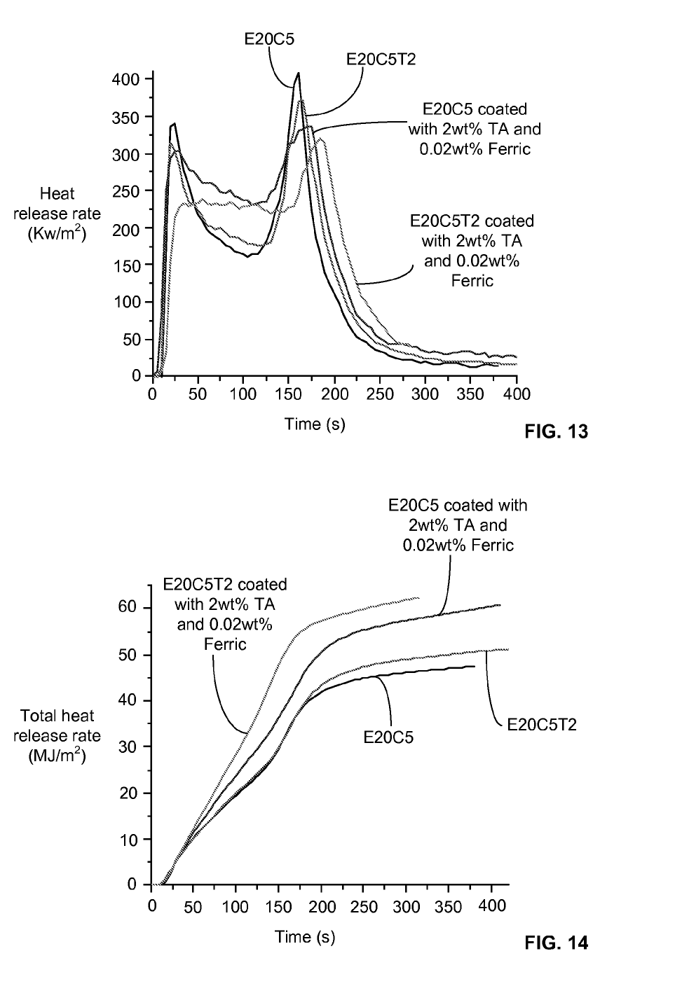

The heat release rate data for the coated and uncoated E20C5 and E20C5T2 aerogel samples are shown in FIG. 13. As shown, each of the coated E20C5 and E20C5T2 samples had a lower peak of heat release rate (PHRR) by nearly 20% and 10% respectively as compared with the uncoated E20C5 and E20C5T2 samples. It is noted that the peak heat release rate of pure epoxy foam is much higher than epoxy/clay/tannin aerogel composites, typically about 1200 kW/m². The TTPHRR also raised for the coated E20C5 and E20C5T2 samples with addition of 2 wt % TA and coating as compared with the uncoated E20C5 and E20C5T2 samples, and the burning time was further prolonged.

The total heat release (THR) rates of the coated and uncoated E20C5 and E20C5T2 aerogel samples are shown in FIG. 14. As shown, the uncoated E20C5T2 aerogel sample included a larger total heat release as compared with the uncoated E20C5 aerogel sample. Even larger total heat releases were associated with the coated E20C5 and E20C5T2 aerogel samples. This phenomenon could be explained by an intumescent mechanism, wherein tannins act as flame retardants in the condensed phase. When the aerogel with TA internally and coated outside is subjected to heat, tannic acid partly melts, blackens, swells up and takes fire, and burns with a brilliant flame. When subjected to heat, the coating layer first burns, resulting in a shorter TTI (Table 4), then the tannins carbonize and form a char layer on the surface exposed to the heat source, which presents poor thermal conductivity and can act as an insulation layer to further prevent decomposition of the aerogel.

The coated E20C5 and E20C5T2 aerogel samples also showed a residue increase as compared with the uncoated E20C5 and E20C5T2 aerogel sample.

Another parameter used for evaluating flammability is FIGRA. FIGRA is defined by the ratio of PHRR to TTPHRR, which indicates the flame spreading rate, providing information of both the effect of time and heat release in a fire, given information of flame spreading rate, the scale of a fire, and the flammability of the material. As Table 4 presents, the FIGRA is lower for the coated E20C5 and E20C5T2 aerogel samples as compared with the uncoated E20C5 and E20C5T2 aerogel samples. The FIGRA is also lower for the uncoated E20C5T2 aerogel sample as compared with the uncoated E20C5 aerogel sample. This suggests that the coated aerogels and the aerogel including the tannin each exhibit a lower tendency to burn compared with uncoated E20C5.

Although the subject matter of the present disclosure has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments. In addition, while a particular feature of the present disclosure may have been described above with respect to only one or more of several illustrated embodiments, such feature may be combined with one or more other features of the other embodiments, as may be desired and advantageous for any given or particular application.

1. A method of forming a tannin-modified porous material, comprising:
forming an aerogel precursor, the aerogel precursor comprising a polymeric material, a tannin, and a liquid dispersion medium;
freezing the aerogel precursor to solidify the liquid dispersion medium; and
freeze drying the aerogel precursor to sublime the dispersion medium and form the tannin-modified porous material.

2. The method of claim 1, wherein the polymeric material comprises an epoxy.

3. The method of any of claim 1, wherein the polymeric material comprises triethylenetetramine and 1,4-butanediol diglycidyl ether.

4. (canceled)

5. The method of claim 1, wherein the aerogel precursor comprises montmorillonite clay.

6. (canceled)

7. (canceled)

8. The method of claim 1, wherein the tannin comprises tannic acid.

9. (canceled)

10. The method of claim 1, further comprising coating the formed tannin-modified porous material with a tannin-containing coating solution comprising an additional tannin dispersed therein.

11. The method of claim 10, wherein the additional tannin comprises tannic acid.

12. (canceled)

13. The method of claim 10, wherein the tannin-containing coating solution comprises tannic acid and ferric iron.

14.-18. (canceled)

19. A method of forming a tannin-modified porous material, comprising:
forming an aerogel precursor, the aerogel precursor comprising a polymeric material and a liquid dispersion medium;
freezing the aerogel precursor to solidify the liquid dispersion medium;
freeze drying the aerogel precursor to sublime the dispersion medium and form a porous material; and
coating the formed porous material with a tannin-containing coating solution comprising a tannin dispersed therein.

20. The method of claim 19, wherein the tannin comprises tannic acid.

21. (canceled)

22. The method of claim 19, wherein the coating solution comprises a tannic acid and ferric iron.

23.-26. (canceled)

27. The method of claim 19, wherein the polymeric material comprises an epoxy.

28. The method of claim 19, wherein the polymeric material comprises triethylenetetramine and 1,4-butanediol diglycidyl ether.

29. (canceled)

30. The method of claim 19, wherein the polymeric material comprises montmorillonite clay.

31.-33. (canceled)

34. An aerogel formed of a tannin-modified porous material, the porous material comprising:
polymeric material present in an amount from about 5 to about 95 parts per 100 parts by weight of the tannin-modified aerogel; and
a tannin present in an amount from about 1 to about 20 parts per 100 parts by weight of the tannin-modified aerogel.

35. The aerogel of claim 34, wherein the polymeric material comprises triethylenetetramine and 1,4-butanediol diglycidyl ether.

36. (canceled)

37. The aerogel of claim 34, wherein the tannin comprises tannic acid.

38. The aerogel of claim 34, wherein the tannin-modified aerogel comprises a coating layer comprising an additional tannin.

39. The aerogel of claim 38, wherein the coating layer further comprises ferric iron.

40. (canceled)

41. (canceled)

42. The aerogel of claim 34, wherein the porous material further comprises a clay present in an amount from about 1 to about 25 parts per 100 parts by weight of the tannin-modified aerogel.
